(19) United States
(12) Patent Application Publication
(10) Pub. No.: US 2012/0326530 A1
(43) Pub. Date: Dec. 27, 2012

(54) ELECTRONIC DEVICE ENABLED TO DECREASE POWER CONSUMPTION

(75) Inventor: XING-HUA TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/231,712

(22) Filed: Sep. 13, 2011

(30) Foreign Application Priority Data
Jun. 27, 2011 (CN) 201110174130.3

(51) Int. Cl. H01H 35/00

(52) U.S. Cl. 307/116

(57) ABSTRACT

An electronic device includes an input interface receiving a power signal, a voltage conversion unit converting the power signal into a voltage signal, a processing unit receiving the voltage signal to operate normally, a load unit, and a control unit electrically connected to the processing unit, the voltage conversion unit and the load unit. The processing unit detects whether the load unit stops operating. In response to the processing unit detecting that the load unit stops operating, the processing unit controls the control unit to cut off an electrical connection between the voltage conversion unit and the load unit, and thereby the voltage conversion unit stops providing the voltage signal to the load unit.

### BACKGROUND

1. Technical Field

The present disclosure generally relates to electronic devices, and particularly to an electronic device enabled to decrease power consumption.

2. Description of Related Art

Many electronic devices are widely used in daily life and industry. A typical electronic device usually powers a load circuit via a power supply. The load circuit may be a signal processing circuit, or a driver circuit, for example. However, in some circumstances, even though the load circuit stops operating, for example, the electronic device still powers the load circuit. Therefore, the power consumption of the electronic device is high, and power is unnecessarily wasted.

What is needed, therefore, is an electronic device enabled to decrease power consumption which can overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a schematic block diagram of an electronic device according to one embodiment, the electronic device including an execution unit.

FIG. 2 is a schematic block diagram of the execution unit of the electronic device in FIG. 1, the execution unit including a control unit.

FIG. 3 is a schematic circuit view of the control unit of the execution unit in FIG. 2.

### DETAILED DESCRIPTION

Reference will now be made to the drawings to describe the preferred and exemplary embodiments in detail.

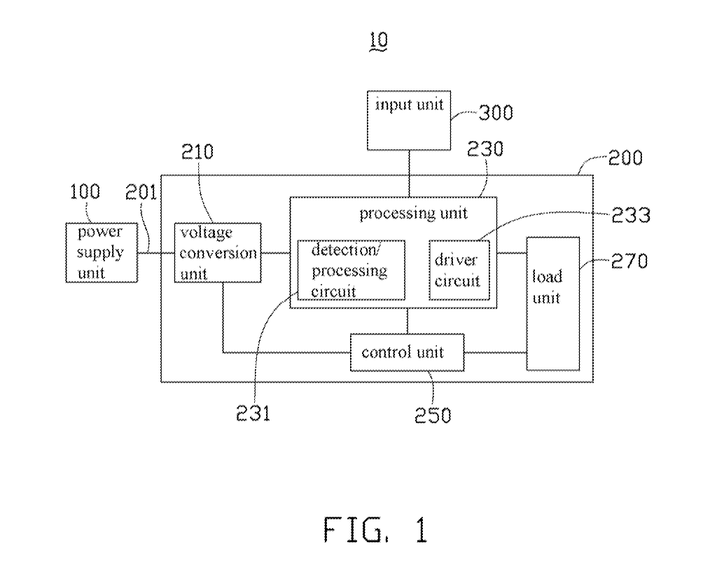

Referring to FIG. 1, a schematic block diagram of an electronic device according to one embodiment is shown. The electronic device 10 may be an electronic device having function for displaying images or playing audio, such as an optical disk player, a MP3, a MP4, a notebook, a flat panel display, a desk computer, or a mobile phone, for example. In this embodiment, the electronic device 10 is a portable optical disk player as an example for illustrating the disclosure.

The electronic device 10 includes a power supply unit 100 and an execution unit 200. The power supply unit 100 provides power to the execution unit 200, and may be a power adapter for rectifying alternating current into direct current as a power signal. The power supply unit 100 also may include a battery for providing the power signal needed by the execution unit 200.

The execution unit 200 includes an input interface 201, a voltage conversion unit 210, a processing unit 230, a control unit 250, and a load unit 270. The voltage conversion unit 210 is electrically connected to the power supply unit 100 via the input interface 201. The voltage conversion unit 210 converts the power signal provided by the power supply unit 100 into various power signals having different voltage values or current values by voltage stepping up, voltage stepping down, and voltage stabilizing, for example, and provides the various power signals to the processing unit 230 and the load unit 270 for operation. In an alternative embodiment, the voltage conversion unit 210 can process the power signal provided by the power supply unit 100 by pulse width modulation, and power regulation, for example. The voltage conversion unit 210 may be a power integrated circuit (IC).

The processing unit 230 is electrically connected to the voltage conversion unit 210 to receive a power signal for operation, for example, the power signal may be a voltage signal having the voltage of 3.3V. The processing unit 230 detects, and controls the operation state of the load unit 270, and in addition, controls the operation state of the control unit 250 according to the operation state of the load unit 270. The processing unit 230 includes a detection/processing circuit 231 and a driver circuit 233 electrically connected to the detection/processing circuit 231. The driver circuit 233 drives the load unit 270, and the detection/processing circuit 231 detects the operation state of the driver circuit 233 to obtain the operation state of the load unit 270 and appropriately adjusts and controls the driver circuit 233 according to the operation state of the load unit 270. In this embodiment, the detection/processing circuit 231 may be a microcontroller (MCU), and the driver circuit 233 may includes a servo unit and a signal processing unit.

The load unit 270 has different operation states under the control of the processing unit 230 based on one or more power signals provided by the voltage conversion unit 210. The load unit 270 may be a circuit for playing video and audio information, such as optical disc core circuit module, display circuit module, or other signal processing circuits.

The control unit 250 is electrically connected to the voltage conversion unit 210, the processing unit 230 and the load unit 270, and selectively conducts or cuts off an electrical connection between the voltage conversion unit 210 and the load unit 270 under control of the processing unit 230.

In this embodiment, in a normal operation state, the processing unit 230 controls the control unit 250 to conduct the electrical connection between the voltage conversion unit 210 and the load unit 270 to allow the load unit 270 to operate normally. When the processing unit 230 detects that the load unit 270 stops operating, the processing unit 230 controls the control unit 250 to cut off the electrical connection between the voltage conversion unit 210 and the load unit 270. The voltage conversion unit 210 stops providing the power signal to the load unit 270, and the power consumption of the electronic device 10 is accordingly decreased. In this embodiment, the situation that the load unit 270 stops operating may be considered that the electronic device 10 is in a standby state.

In this embodiment, the electronic device 10 further includes an input unit 300 for receiving an operation direction from a user. The input unit 300 may be a remote control interface and/or an operation mode selection key interface for the user to select an operation state of the load unit 270, such as shutdown, standby or other operation states. The detection/processing circuit 231 detects a state of the input unit 300 to obtain information from the user and controls the operation state of the driver circuit 233 according to the information, and further controls the operation state of the load unit 270.

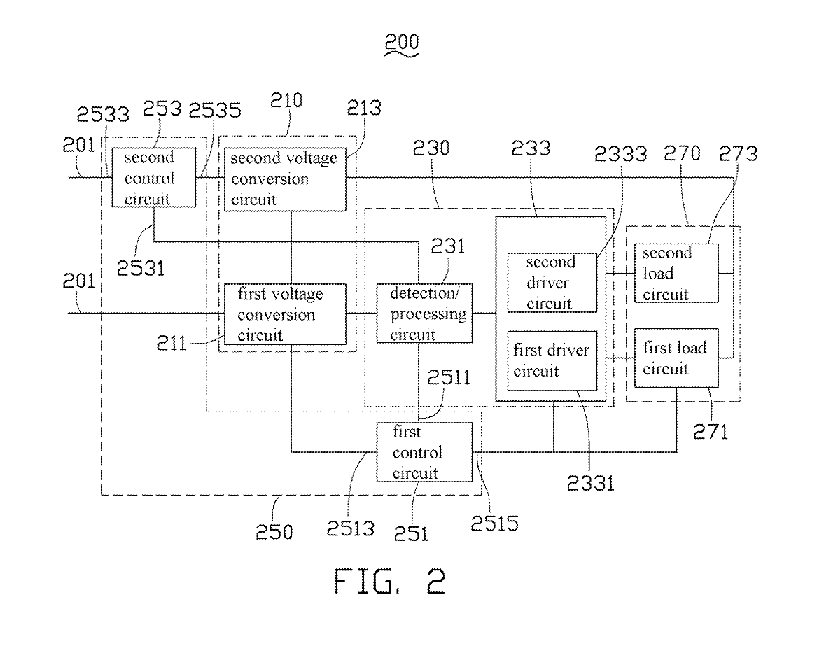

Referring to FIG. 2, a schematic block diagram of the execution unit 200 in FIG. 1 is shown.

When the load unit 270 includes one load circuit, such as a first load circuit 271. The first load circuit 271 is driven by a first driver circuit 2331 of the driver circuit 233 and controlled by a first control circuit 251 of the control unit 250. In addition, a first voltage conversion circuit 211 of the voltage conversion unit 210 provides a first power signal having a first voltage to the detection/processing circuit 231 and to the first driver circuit 2331 and the first load circuit 271 via the first control circuit 251. In this embodiment, the first load circuit 271 may be a display circuit module, and the first driver circuit 2331 may be a signal processing/driver circuit to drive the display circuit module for displaying images.

The first voltage conversion circuit 211 is electrically connected to the input interface 201 to receive and convert the power signal provided by the power supply unit 100 to obtain the first power signal having the first voltage, such as 3.3V. In addition, provides the first power signal to the detection/processing circuit 231 and to the first driver circuit 2331 and the first load circuit 271 via the first control circuit 251. The first driver circuit 2331 is electrically connected between the detection/processing circuit 231 and the first load circuit 271, and controlled by the detection/processing circuit 231 to drive the first load circuit 271. The first control circuit 251 includes a first control terminal 2511, a first input terminal 2513, and a first output terminal 2515. The first control terminal 2511 is electrically connected to the detection/processing circuit 231, the first input terminal 2513 is electrically connected to the first voltage conversion circuit 211, and the first output terminal 2515 is electrically connected to the first driver circuit 2331 and the first load circuit 271. The first control circuit 251 is controlled by the detection/processing circuit 231 to selectively conduct or cut off the electrical connection between first voltage conversion circuit 211 and the first driver circuit 2331, the first load circuit 271.

In this embodiment, the detection/processing circuit 231 obtains the operation state of the first load circuit 271 by detecting the operation state of the first driver circuit 2331. In the normal operation state or when the detection/processing circuit 231 detects an operation direction from the user, the detection/processing circuit 231 controls the first driver circuit 2331 to drive the first load circuit 271, and outputs a first control signal to the first control circuit 251. The first control circuit 251 receives the first control signal via the first control terminal 2511, and conducts an electrical connection between the first input terminal 2513 and the first output terminal 2515. When the detection/processing circuit 231 detects that the first load circuit 271 stops operating, the detection/processing circuit 231 outputs a second control signal to the first control circuit 251. The first control circuit 251 receives the second control signal and cuts off the electrical connection between the first input terminal 2513 and the first output terminal 2515. In this embodiment, the first control signal may be a high level voltage signal, such as 3.3V, and the second control signal may be a low level voltage signal, such as 0V. In an alternative embodiment, the first control signal may be a low level voltage signal and the second control signal may be a high level voltage signal.

Furthermore, when the load unit 270 further includes a second load circuit 273, the second load circuit 273 is driven by a second driver circuit 2333 of the driver circuit 233. The second load circuit 273 may be a core circuit module, and the second driver circuit 2333 may be a servo unit for driving the core circuit module.

The voltage conversion unit 210 further includes a second voltage conversion circuit 213 electrically connected to the input interface 201 via a second control circuit 253 of the control unit 250. The second voltage conversion circuit 213 is controlled by the second control circuit 253 to receive the power signal provided by the power supply unit 100, converts the power signal into a second power signal having a second voltage, such as 5V, and provides the second power signal to the second load circuit 273. The second power signal can be also provided to the first load circuit 271 if required.

The second driver circuit 2333 is electrically connected between the detection/processing circuit 231 and the second load circuit 273, and is controlled by the detection/processing circuit 231 to drive the second load circuit 273. The second driver circuit 2333 can operate based on the first power signal, the second power signal, or both the first and the second power signals. In this embodiment, the second driver circuit 2333 operates based on the first power signal.

The second control circuit 253 includes a second control terminal 2531, a second input terminal 2533, and a second output terminal 2535. The second control terminal 2531 is electrically connected to the detection/processing circuit 231, the second input terminal 2533 is electrically connected to the input interface 201, and the second output terminal 2535 is electrically connected to the second voltage conversion circuit 213. The second control circuit 253 is controlled by the detection/processing circuit 231 to selectively conduct or cut off the electrical connection between the input interface 201 and the second voltage conversion circuit 213.

In this embodiment, the detection/processing circuit 231 obtains the operation state of the second load circuit 273 by detecting the operation state of the second driver circuit 2333. In the normal operation state or when the detection/processing circuit 231 detects an operation direction from the user, the detection/processing circuit 231 controls the second driver circuit 2333 to drive the second load circuit 273, and outputs a third control signal to the second control circuit 253. The second control circuit 253 receives the third control signal via the second control terminal 2531, and conducts an electrical connection between the second input terminal 2533 and the second output terminal 2535. The detection/processing circuit 231 outputs a fourth control signal to the second control circuit 253 when detecting that the second load circuit 273 stops operating. The second control circuit 253 receives the fourth control signal and cuts off the electrical connection between the second input terminal 2533 and the second output terminal 2535.

In an alternative embodiment, the load unit 270 can further include a third load circuit, the third load circuit can operate based on the first power signal, or the second power signal, or a third power signal having a third voltage different from the first and the second voltage. If the third load circuit operates based on the first power signal, a connection of the third load circuit with other circuit elements, such as the control unit 250 and the processing unit 230, may be similar to the first load circuit 271. If the third load circuit operates based on the second power signal or the third power signal, the connection of the third load circuit with other circuit elements may be similar to the second load circuit 273.

In an alternative embodiment, the detection/processing circuit 231 may first wait for a certain time when detecting that the load unit 270 stops operating. If the user does not output a direction to start the load unit 270 during the certain time, the detection/processing circuit 231 controls the control unit 250 to cut off the electrical connection between the voltage conversion unit 210 and the load unit 270. The detection/processing circuit 231 can also directly detect the state of the input unit 300 and control the driver circuit 233 and the control unit 250 according to the direction of the user.

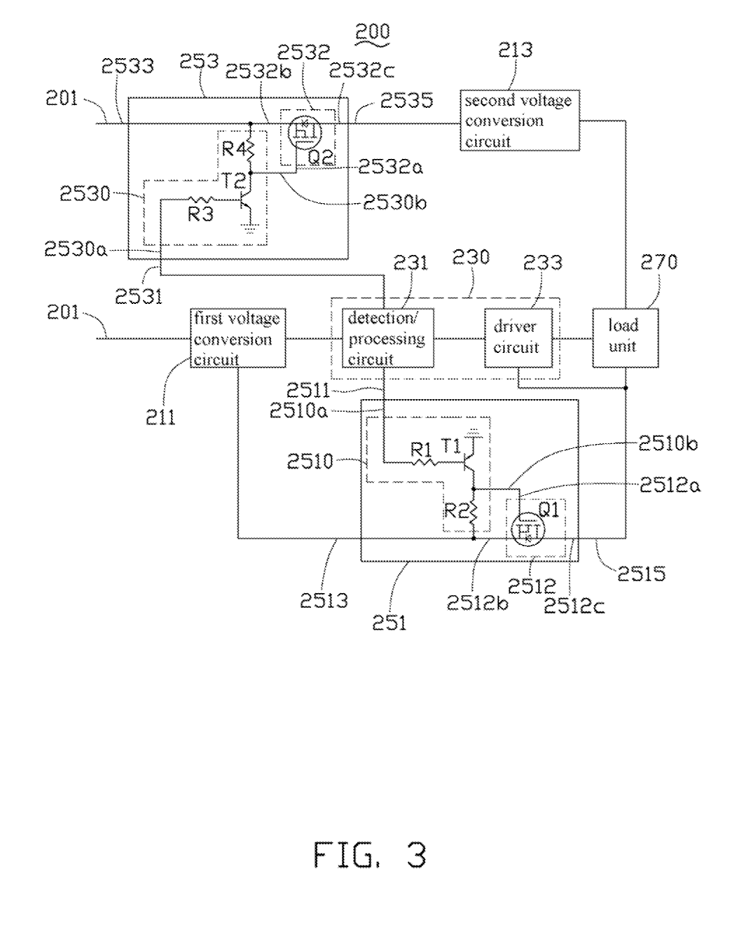

In this embodiment, the configuration and the function of the first and the second control circuit 251, 253 are same. Referring to FIG. 3, a schematic circuit view of the control unit 250 is shown.

The first control circuit 251 includes a first detection circuit 2510 and a first switch circuit 2512, and the second control circuit 253 includes a second detection circuit 2530 and a second switch circuit 2532. The first detection circuit 2510 includes a first detection terminal 2510a, resistors R1, R2, a transistor T1, and a first detection output terminal 2510b. The transistor T1 is a p-type transistor. The first detection terminal 2510a is electrically connected to the first control terminal 2511, and to a base of the transistor T1 via the resistor R1. A collector is electrically connected to the first detection output terminal 2510b, and also electrically connected to the first input terminal 2513 via the resistor R2. An emitter of the transistor T1 is grounded. The first switch circuit 2512 includes a metal-oxide semiconductor (MOS) transistor Q1, a first control terminal 2512a, a first conduction terminal 2512b, and a second conduction terminal 2512c. The first control terminal 2512a is electrically connected to the first detection output terminal 2510b, the first conduction terminal 2512b is electrically connected to the first input terminal 2513, and the second conduction terminal 2512c is electrically connected to the first output terminal 2515. A gate electrode of the MOS transistor Q1 is electrically connected to the first control terminal 2512a, or is the first control terminal 2512a. A drain electrode of the MOS transistor Q1 is electrically connected to the first conduction terminal 2512b, or is the first conduction terminal 2512b. A source electrode of the MOS transistor Q1 is electrically connected to the second conduction terminal 2512c, or is the second conduction terminal 2512c.

The second detection circuit 2530 also includes a second detection terminal 2530a, resistors R3, R4, a transistor T2, and a second detection output terminal 2530b. The second switch circuit 2532 also includes a MOS transistor Q2, a second control terminal 2532a, a third conduction terminal 2532b, and a fourth conduction terminal 2532c. In this embodiment, a configuration of the second detection circuit 2530 is the same as that of the first detection circuit 2510, and a configuration of the second switch circuit 2532 is the same as that of the first switch circuit 2512. Therefore, the configuration of the second control circuit 253 is not described here. In an alternative embodiment, the second detection circuit 2530 and the second switch circuit 2532 can have different interior configuration to achieve the same function as that of the first detection circuit 2510 and the first switch circuit 2512.

When the detection/processing circuit 231 detects that the load unit 270 stops operating, the detection/processing circuit 231 outputs the second control signal to the first control terminal 2511 of the first control circuit 251 and outputs the fourth control signal to the second control terminal 2531 of the second control circuit 253. Then the transistors T1 of the first and the second detection circuits 2510, 2530 are turned off, and the first and the second detection output terminals 2510b, 2530b respectively outputs a high level voltage signal to the first and the second control terminals 2512a, 2532a. Therefore, the gate electrodes of the MOS transistors Q1, Q2 receive the high level voltage signals and the MOS transistors Q1, Q2 are turned off. Accordingly, an electrical connection between the first and the second conduction terminals 2512b, 2512c is cut off, and an electrical connection between the third and the fourth conduction terminals 2532b, 2532c is cut off. That is, the electrical connection between the first input terminal 2513 and the first output terminal 2515 is cut off, and an electrical connection between the second input terminal 2533 and the second output terminal 2535 is cut off. Thus, the first voltage conversion circuit 211 stops providing the first power signal to the driver circuit 233 and the load unit 270, and the second voltage conversion circuit 213 is disconnected to the input interface 201 and then also stops providing the second power signal to the load unit 270.

When the load unit 270 stops operating, the electronic device 10 accordingly stops providing power to the load unit 270, the corresponding driver circuit 233 for driving the load unit 270, and other circuit elements, such as the second voltage conversion circuit 213. Therefore, the power consumption of electronic device 10 is decreased.

It is believed that the present embodiments and their advantages will be understood from the foregoing description, and it will be apparent that various changes may be made thereto without departing from the spirit and scope of the embodiments or sacrificing all of their material advantages.

What is claimed is:

1. An electronic device, comprising:
an input interface configured to receive a power signal;
a voltage conversion unit configured to convert the power signal into a voltage signal;
a processing unit configured to receive the voltage signal to operate normally;
a load unit; and
a control unit electrically connected to the processing unit, the voltage conversion unit, and the load unit;
wherein the processing unit is further configured to detect whether the load unit stops operating, and in response to the processing unit detecting that the load unit stops operating, the processing unit controls the control unit to cut off an electrical connection between the voltage conversion unit and the load unit, and thereby the voltage conversion unit stops providing the voltage signal to the load unit.

2. The electronic device of claim 1, wherein the control unit comprises a control terminal, an input terminal, and an output terminal, the control terminal electrically connected to the processing unit, the input terminal electrically connected to the voltage conversion unit, and the output terminal electrically connected to the load unit, and in response to the processing unit detecting that the load unit stops operating, the processing unit outputs a control signal to the control unit to cut off an electrical connection between the input terminal and the output terminal.

3. The electronic device of claim 2, wherein the processing unit comprises a detection/processing circuit and a driver circuit, the detection/processing circuit is configured to detect whether the load unit stops operating via the driver circuit and control the control unit, and the driver circuit is electrically connected to the detection/processing circuit and the load unit.

4. The electronic device of claim 3, wherein the output terminal is further electrically connected to the driver circuit.

5. The electronic device of claim 1, wherein the load unit comprises a first load circuit and a second load circuit, the voltage conversion unit comprises a first voltage conversion circuit and a second voltage conversion circuit, and the control unit comprises a first control circuit and a second control circuit, the first and the second voltage conversion circuits configured to respectively convert the power signal into a first voltage signal and a second voltage signal, the first load circuit configured to operate based on the first voltage signal, the second load circuit configured to operate based on the second voltage signal, and the first and the second control circuits configured to be controlled by the processing unit to respectively cut off electrical connections between the first and second voltage conversion circuits and the first and the second load circuits in response to the processing unit detecting that the first and the second load circuits stop operating.

6. The electronic device of claim 5, wherein the processing unit comprises a detection/processing circuit, a first driver circuit, and a second driver circuit, the detection/processing circuit configured to receive the first voltage signal to operate and control the first and the second control circuits, and the first and the second driver circuits configured to respectively drive the first and the second load circuits.

7. The electronic device of claim 6, wherein the first control circuit is electrically connected between the first voltage conversion circuit and the first load circuit, the second control circuit is electrically connected between the input interface and the second voltage conversion circuit, and the second voltage conversion circuit is electrically connected to the second load circuit.

8. The electronic device of claim 7, wherein the first control circuit is further electrically connected between the first voltage conversion circuit and the first driver circuit.

9. The electronic device of claim 1, further comprising an input unit configured to receive directions respectively to start the load unit and stop an operation of the load unit.

10. The electronic device of claim 9, wherein the processing unit is further configured to detect the directions, when the input unit receives a direction to stop the operation of the load unit, the processing unit controls the control unit to cut off the electrical connection between the voltage conversion unit and the load unit.

11. An electronic device, comprising:
an input interface configured to receive a power signal;
a voltage conversion unit configured to convert the power signal into a voltage signal;
a processing unit;
a load unit; and
a control unit;
wherein the voltage signal is provided to the processing unit and to the load unit via the control unit, in response to the electronic device operating in a normal operation state, the processing unit controls the control unit to conduct an electrical connection between the voltage conversion unit and the load unit, and in response to the processing unit detecting that the load unit stops operating, the processing unit controls the control unit to cut off the electrical connection between the voltage conversion unit and the load unit.

12. The electronic device of claim 11, wherein the processing unit comprises a detection/processing unit and a first driver circuit, the voltage conversion unit comprises a first voltage conversion circuit, and the load unit comprises a first load circuit, the first voltage conversion circuit configured to convert the power signal to a first voltage signal, the detection/processing unit configured to receive the first voltage signal to detect whether the first load circuit stops operation via detecting an operation state of the first driver circuit.

13. The electronic device of claim 12, wherein the control unit comprises a first control circuit, and the first control circuit comprises a first control terminal, a first input terminal, and a first output terminal, the first control terminal electrically connected to the detection/processing circuit, the first input terminal electrically connected to the first voltage conversion circuit, and the first output terminal electrically connected to the first load circuit.

14. The electronic device of claim 13, wherein the first output terminal is further electrically connected to the first driver circuit.

15. The electronic device of claim 14, wherein in response to the detection/processing circuit detecting that the first load circuit stops operating, the detection/processing circuit controls the first control circuit to cut off an electrical connection between the first input terminal and the first output terminal.

16. The electronic device of claim 13, wherein the first control circuit further includes a transistor, a first resistor, a second resistor, and a switch element, the switch element comprising a control terminal, a first conduction terminal and a second conduction terminal, a base of the transistor electrically connected to the first control terminal of the first control circuit via the first resistor, a collector of the transistor electrically connected to the first input terminal via the second resistor and further connected to the control terminal of the switch element, an emitter of the transistor being grounded, the first conduction terminal electrically connected to the first input terminal, and the second conduction terminal electrically connected to the first output terminal.

17. The electronic device of claim 13, wherein the load unit further comprises a second load circuit, and the driver circuit further comprises a second driver circuit configured to drive the second load circuit and electrically connected to the detection/processing unit.

18. The electronic device of claim 17, wherein the voltage conversion unit further comprises a second voltage conversion circuit, and the control unit further comprises a second control circuit, the second control circuit configured to electrically connected between the input interface and the second voltage conversion circuit and be controlled by the detection/processing unit to cut off an electrical connection between the input interface and the second voltage conversion circuit, and the second voltage conversion circuit configured to electrical connected to the second load circuit.

19. The electronic device of claim 11, wherein further comprising an input unit configured to receive directions respectively to start the load unit and stop an operation of the load unit.

20. The electronic device of claim 19, wherein the processing unit is further configured to detect the directions, in response to the input unit receiving a direction to stop the operation the load unit, the processing unit controls the control unit to cut off the electrical connection between the voltage conversion unit and the load unit.
